(19) United States
(12) Patent Application Publication
(10) Pub. No.: US 2020/0079946 A1
(43) Pub. Date: Mar. 12, 2020

(54) RUBBER COMPOSITION HAVING A LOW CARBON BLACK CONTENT AND A HIGH CONTENT OF ANOTHER FILLER

(71) Applicant: Compagnie Generale des Etablissements Michelin, Clermont-Ferrand (FR)

(72) Inventors: SÉVERINE BIZET, Clermont-Ferrand (FR); ALINE RIOU, Clermont-Ferrand (FR); BÉATRICE LOPEZ, Clermont-Ferrand (FR)

(21) Appl. No.: 16/470,132

(22) PCT Filed: Dec. 14, 2017
(86) PCT No.: PCT/FR2017/053559

§ 371 Date: Jun. 14, 2019

(30) Foreign Application Priority Data
Dec. 16, 2016 (FR) 1662658

(51) Int. Cl. C08L 23/22; C08K 5/00; C08K 3/04; B60C 1/00

(52) U.S. Cl. CPC C08L 23/22; B60C 1/0008; C08K 3/04; C08K 5/0016

(57) ABSTRACT

A rubber composition is based on at least one elastomer, carbon black in a content ranging from 2 to 15 phr, graphite in a content of greater than or equal to 60 phr and a plasticizing oil, the content of which is less than or equal to 30 phr. The composition may be used especially as the inner liner of a tire.

The field of the present invention is that of rubber compositions for tyres, especially that of compositions intended to be used as the inner liner for tyres.

Tubeless tyres have an inner surface of low permeability to air in order to prevent deflation of the tyre and to protect the sensitive internal regions of the tyre from admissions of oxygen and water, such as the plies comprising oxidation-sensitive metal cords. This protection makes it possible to improve the endurance of the tyre. Such protection of the inner surface of tyres is generally achieved with inner liners consisting of elastomeric compositions based on butyl rubber and carbon black.

However, since savings in fuel and the need to protect the environment have become a priority, it is desirable to produce inner liners that have the lowest possible weight and hysteresis, in order to obtain improved rolling resistance of the tyre. In point of fact, the performance in terms of impermeability to air of butyl rubbers is related to a not insignificant minimum thickness (of the order of a millimetre) and thus to a certain weight, which does not make it possible to efficiently meet these new requirements.

Thus, it is necessary to add lamellar fillers, which may be semi-reinforcing fillers, to the inner liner rubber composition in order to improve its impermeability.

However, in large amounts, these semi-reinforcing fillers are detrimental to certain properties of the cured composition: for example, degradation of the mechanical properties, in particular of the flexural strength and the cold stiffness properties, are observed.

There is therefore a constant need to reduce the weight of the inner liners without affecting the other properties essential to these inner liners.

Various solutions have been envisaged for overcoming these drawbacks.

One solution consisted in introducing plasticizers of oil type to overcome the mechanical property problems presented previously. However, the addition of plasticizing oils to inner liner rubber compositions greatly penalizes their impermeability.

Other solutions consist in using lamellar fillers such as graphite in order to improve the impermeability of the composition, in combination with a low content of carbon black. Thus, patent application WO 2016/001226 from the Applicants describes an inner liner rubber composition for a tyre based on at least one butyl rubber, a low content of carbon black, graphite and a hydrocarbon-based plasticizing oil, which has a good compromise of properties.

Inner liner rubber compositions for a tyre based on at least one butyl rubber, a plasticizing oil, a low content of carbon black and a high content of lamellar clay are also known from EP 2671917 A1. However, these compositions do not have a good compromise of properties (cold stiffness, flexural strength and impermeability).

The Applicants pursued their research and have discovered, surprisingly, that the combined use, in a tyre inner liner composition, of carbon black and graphite in very specific respective contents and of plasticizing oil allows this composition to have improved mechanical properties without reducing its impermeability and cold stiffness properties.

One subject of the invention is thus a rubber composition based on at least:
one elastomer,
carbon black in a content ranging from 2 to 15 phr,
graphite in a content of greater than or equal to 60 phr, and
a plasticizing oil, the content of which is less than or equal to 30 phr.

Such a composition according to the invention has mechanical properties, especially in terms of breaking stress and breaking energy, which are improved relative to the prior art, while at the same time conserving good impermeability properties.

Preferentially, the invention relates to a composition as defined above, in which the graphite content is less than or equal to 100 phr.

Preferentially, the invention relates to a composition as defined above, in which the graphite content is greater than or equal to 65 phr, preferably greater than or equal to 70 phr, more preferentially greater than or equal to 75 phr.

Preferentially, the invention relates to a composition as defined above, in which the carbon black content is less than or equal to 9 phr.

Preferentially, the invention relates to a composition as defined above, in which the carbon black content ranges from 2 to 9 phr.

Preferentially, the invention relates to a composition as defined above, in which the elastomer is a butyl elastomer or a mixture of butyl elastomers.

Preferentially, the invention relates to a composition as defined above, in which the butyl elastomer(s) are chosen from isobutylene polymers, copolymers of isobutylene and of isoprene, halogenated isobutylene polymers and halogenated copolymers of isobutylene and of isoprene.

Preferentially, the invention relates to a composition as defined above, also comprising at least one second elastomer different from a butyl elastomer or a mixture of butyl elastomers.

Preferentially, the invention relates to a composition as defined above, in which the second elastomer is a diene elastomer chosen from polybutadienes, synthetic polyisoprenes, natural rubber, butadiene copolymers, isoprene copolymers and mixtures of these elastomers.

Preferentially, the invention relates to a composition as defined above, in which the second elastomer is a diene elastomer chosen from butadiene-styrene copolymers, isoprene-butadiene copolymers, isoprene-styrene copolymers and isoprene-butadiene-styrene copolymers, and mixtures of these polymers.

Preferentially, the invention relates to a composition as defined above, in which the butyl elastomer(s) are present in a content of greater than or equal to 50 phr.

Preferentially, the invention relates to a composition as defined above, in which the butyl elastomer(s) are the only elastomers of the composition.

Preferentially, the invention relates to a composition as defined above, which also comprises a plasticizing resin, the content of which is less than or equal to 5 phr.

Preferentially, the invention relates to a composition as defined above, in which the plasticizing oil is chosen from liquid diene polymers, naphthenic oils, paraffinic oils, MES oils, TDAE oils, mineral oils, plant oils, ether plasticizers, ester plasticizers, phosphate plasticizers, sulfonate plasticizers, and mixtures of these compounds.

Preferentially, the invention relates to a composition as defined above, in which the plasticizing oil content is greater than or equal to 5 phr.

Preferentially, the invention relates to a composition as defined above, in which the plasticizing oil content ranges from 5 to 30 phr, preferably from 10 to 20 phr.

A subject of the invention is also an inner liner comprising at least one composition of the invention as defined above.

A subject of the invention is also a tyre comprising at least one composition of the invention as defined above or comprising an inner liner as defined above.

The invention and the advantages thereof will be readily understood in the light of the description and the implementation examples that follow.

### Measurements and Test Used

### 1) Properties After Curing: Breaking

The breaking measurements are performed at 100° C. and in accordance with the French standard NF T 46-002 of September 1988. The breaking specimens are of H2 type as described in the standard NF ISO 37 of 1 Mar. 2012, with the exception of the thickness, which is 2.5 cm. The force to be exerted to obtain breaking (breaking stress, in MPa (in N/mm)) is determined and the elongation at break (in %) is measured.

Thus, the energy to bring about breaking (breaking energy) of the specimen, which is the product of the breaking stress and the elongation at break (breaking energy=breaking stress*elongation at break), may be determined.

The results are indicated on a basis of 100; the arbitrary value 100 is attributed to the control, respectively, for the breaking stress and for the breaking energy. A result of less than 100 for the breaking stress or the breaking energy indicates a decrease in the value concerned, which corresponds to a reduction in the breaking strength performance, and, conversely, a result greater than 100 indicates an increase in this value, which corresponds to an improvement in this performance.

### 2) Properties After Curing: Dynamic Properties

The dynamic glass transition temperature is measured on a viscosity analyser (Metravib VA4000) according to the standard ASTM D 5992-96 (2011).

The response of a specimen consisting of two cylindrical pellets each 2 mm thick, 400 mm² in cross section and 1 cm in diameter is recorded. The specimen is subjected to an alternating simple shearing sinusoidal stress, at a frequency of 10 Hz, at a stress of 0.1 MPa, over a temperature sweep between −60° C. and +60° C.

The positioning of the dynamic glass transition temperature (Tg) is defined by the maximum positioning of tan δ (ratio of the viscous and elastic moduli=G″/G′).

### 3) Properties After Curing: Permeability

The permeability values are measured using a Mocon Oxtran 2/60 permeability “tester” at 40° C. Cured samples in the form of discs with a predetermined thickness (approximately 0.8 to 1 mm) are fitted to the device and rendered leaktight with vacuum grease. One of the faces of the disc is kept under 10 psi of nitrogen while the other face is kept under 10 psi of oxygen (1 psi=6894.76 Pa). The increase in the oxygen concentration is monitored using a “Coulox” oxygen detector on the face kept under nitrogen. The oxygen concentration on the face kept under nitrogen which makes it possible to achieve a constant value, used to determine the permeability to oxygen, is recorded.

An arbitrary value of 100 is given for the permeability to oxygen of the control, a result of less than 100 indicating a reduction in the permeability to oxygen and thus better impermeability.

### DETAILED DESCRIPTION

One subject of the invention is thus a rubber composition based on at least:
one elastomer,
carbon black in a content ranging from 2 to 15 phr,
graphite in a content of greater than or equal to 60 phr, and
a plasticizing oil, the content of which is less than or equal to 30 phr.

The expression “composition based on” means a composition including or comprising the mixture and/or the product of the in situ reaction of the various constituents used, some of these constituents being able to, and/or intended to, react with each other, at least partially, during the various phases of manufacture of the composition or during the subsequent curing, modifying the composition as it is prepared at the start. Thus, the compositions as used for the invention may be different in the non-crosslinked state and in the crosslinked state.

In the present description, unless expressly indicated otherwise, all the percentages (%) shown are mass percentages.

Furthermore, any interval of values denoted by the expression “between a and b” represents the range of values extending from more than a to less than b (that is to say, limits a and b excluded), whereas any interval of values denoted by the expression “from a to b” means the range of values extending from a up to b (that is to say, including the strict limits a and b). In the present document, when an interval of values is denoted by the expression “from a to b”, the interval represented by the expression “between a and b” is also and preferentially denoted.

In the present patent application, the term “part per hundred parts of elastomer” or “phr” means the part by weight of a constituent per 100 parts by weight of the elastomer(s), i.e. of the total weight of the elastomer(s). Thus, a constituent at 60 phr will mean, for example, 60 g of this constituent per 100 g of elastomer.

For the purposes of the present invention, the term “predominantly” or “predominant” refers to a compound which represents the largest amount by mass or by weight among the compounds of the same type. In other words, the mass of this compound represents more than 50% of the total mass of the compounds of the same type in the composition. By way of example, a “predominant” reinforcing filler is the reinforcing filler representing the largest mass relative to the total mass of the reinforcing fillers in the composition. In other words, the mass of this reinforcing filler represents more than 50% of the total mass of the reinforcing fillers in the composition.

Within the context of the invention, the compounds, the reagents and other components mentioned in the description may be of fossil or biobased origin. In the latter case, they may partially or completely result from biomass or be obtained from renewable starting materials derived from biomass. This especially concerns monomers, polymers, plasticizers, fillers, etc.

Elastomer

As is customary in the present patent application, the terms “elastomer” and “rubber”, which are interchangeable, are used equivalently in the text.

The composition in accordance with the invention may comprise one or more elastomers, i.e. a mixture or a blend of two or more elastomers. This is also referred to as an elastomeric matrix, i.e. all of the elastomers (or rubbers) of the composition of the invention. Thus, the elastomeric matrix may especially consist of a single elastomer but also of a mixture or blend of two or more elastomers.

Preferentially, the elastomer in the composition of the invention is a butyl elastomer or a mixture of butyl elastomers.

For the purposes of the present invention, the term “butyl rubber” or “butyl elastomer” means an isobutylene homopolymer (isobutylene polymer) or a copolymer of isobutylene and of isoprene, and also the halogenated derivatives, in particular generally brominated or chlorinated derivatives, of these isobutylene homopolymers and of these copolymers of isobutylene and of isoprene.

Particularly preferably, the butyl rubber(s) that may be used in the composition according to the invention are chosen from isobutylene rubbers, copolymers of isobutylene and of isoprene (IIR), bromobutyl rubbers such as the bromoisobutylene/isoprene copolymer (BIIR) and chlorobutyl rubbers such as the chloroisobutylene/isoprene copolymer (CIIR), and mixtures of these rubbers.

By extension of the preceding definition, the name “butyl rubber” will also include copolymers of isobutylene and of styrene derivatives, such as brominated isobutylene/methylstyrene copolymers (BIMSs), among which is included in particular the elastomer known as Exxpro sold by the company Exxon.

The term “diene” elastomer or rubber should be understood as meaning, in a known manner, one or more elastomers derived at least in part (i.e. a homopolymer or a copolymer) from diene monomers (monomers bearing two conjugated or non-conjugated carbon-carbon double bonds).

These diene elastomers may be classified into two categories: “essentially unsaturated” or “essentially saturated”.

“Essentially unsaturated” is understood generally to refer to a diene elastomer derived at least in part from conjugated diene monomers with a content of units of diene origin (conjugated dienes) which is greater than 15% (mol %). In the category of “essentially unsaturated” diene elastomers, “highly unsaturated” diene elastomer is intended to refer in particular to a diene elastomer with a content of units of diene origin (conjugated dienes) which is greater than 50% (mol %).

Thus it is that diene elastomers, such as certain butyl rubbers or copolymers of dienes and of α-olefins of EPDM type, can be described as “essentially saturated” diene elastomers (low or very low content, always less than 15% (mol %), of units of diene origin).

Given these definitions, the term “diene elastomer”, irrespective of the above category, that may be used in the elastomeric matrix of the rubber composition in accordance with the invention more particularly means:
(a)—any homopolymer obtained by polymerization of a conjugated diene monomer containing from 4 to 12 carbon atoms;
(b)—any copolymer obtained by copolymerization of one or more dienes conjugated with each other or with one or more vinylaromatic compounds containing from 8 to 20 carbon atoms;
(c)—a ternary copolymer obtained by copolymerization of ethylene and of an α-olefin containing from 3 to 6 carbon atoms with a non-conjugated diene monomer containing from 6 to 12 carbon atoms, for instance the elastomers obtained from ethylene and propylene with a non-conjugated diene monomer of the abovementioned type, such as, in particular, 1,4-hexadiene, ethylidenenorbornene or dicyclopentadiene;
(d)—a copolymer of isobutene and of isoprene (butyl rubber) and also the halogenated versions, in particular chlorinated or brominated versions, of this type of copolymer.

As conjugated dienes, the following are especially suitable: 1,3-butadiene, 2-methyl-1,3-butadiene, 2,3-di(C1-C5 alkyl)-1,3-butadienes, such as, for example, 2,3-dimethyl-1,3-butadiene, 2,3-diethyl-1,3-butadiene, 2-methyl-3-ethyl-1,3-butadiene, 2-methyl-3-isopropyl-1,3-butadiene, an aryl-1,3-butadiene, 1,3-pentadiene or 2,4-hexadiene. As vinylaromatic compounds, the following are suitable, for example: styrene, ortho-, meta- or para-methylstyrene, the “vinyltoluene” commercial mixture, para-(tert-butyl)styrene, methoxystyrenes, chlorostyrenes, vinylmesitylene, divinylbenzene or vinylnaphthalene.

The diene copolymers mentioned previously (category (b)) may contain between 99% and 20% by weight of diene units and between 1% and 80% by weight of vinylaromatic units. The elastomers may have any microstructure, which depends on the polymerization conditions used, in particular on the presence or absence of a modifying and/or randomizing agent and on the amounts of modifying and/or randomizing agent used. The elastomers may be, for example, block, random, sequential or microsequential elastomers and may be prepared in dispersion or in solution; they may be coupled and/or star-branched or else functionalized with a coupling and/or star-branching or functionalization agent.

The following are suitable: polybutadienes and in particular those with a content (mol %) of 1,2- units of between 4% and 80% or those with a content (mol %) of cis-1,4 of greater than 80%, polyisoprenes, butadiene/styrene copolymers, in particular those with a styrene content of between 5% and 50% by weight and more particularly between 20% and 40% by weight, a content (mol %) of -1,2 bonds in the butadiene part of between 4% and 65%, a content (mol %) of trans-1,4 bonds of between 20% and 80%, butadiene/isoprene copolymers and especially those with an isoprene content of between 5% and 90% by weight and a glass transition temperature (Tg, measured according to ASTM D3418) of −40° C. to −80° C., isoprene/styrene copolymers and especially those with a styrene content of between 5% and 50% by weight and a Tg of between −25° C. and −50° C. In the case of butadiene/styrene/isoprene copolymers, those which are more especially suitable are the ones with a styrene content of between 5% and 50% by weight and more particularly of between 10% and 40%, an isoprene content of between 15% and 60% by weight and more particularly of between 20% and 50%, a butadiene content of between 5% and 50% by weight and more particularly of between 20% and 40%, a content (mol %) of -1,2- units of the butadiene part of between 4% and 85%, a content (mol %) of trans-1,4- units of the butadiene part of between 6% and 80%, a content (mol %) of -1,2- plus -3,4- units of the isoprene part of between 5% and 70% and a content (mol %) of trans-1,4- units of the isoprene part of between 10% and 50%, and more generally any butadiene/styrene/isoprene copolymer with a Tg of between −20° C. and −70° C.

The term “isoprene elastomer” means, in a known manner, an isoprene homopolymer or copolymer, in other words a diene elastomer chosen from the group consisting of natural rubber (NR), synthetic polyisoprenes (IRs), the various isoprene copolymers, and mixtures of these elastomers. Among the isoprene copolymers, mention will be made in particular of isoprene/styrene (SIR), isoprene/butadiene (BIR) or isoprene/butadiene/styrene (SBIR) copolymers. This isoprene elastomer is preferably natural rubber or a synthetic cis-1,4-polyisoprene; use is preferably made, among these synthetic polyisoprenes, of polyisoprenes with a content (mol %) of cis-1,4- bonds of greater than 90%, even more preferably of greater than 98%.

Preferentially, the composition of the invention may comprise at least one second elastomer different from the butyl elastomer(s). As second elastomer present in the composition, mention may be made especially of diene elastomers other than the butyl elastomers mentioned previously.

More preferentially, the second elastomer is a diene elastomer chosen from polybutadienes, synthetic polyisoprenes, natural rubber, butadiene copolymers, isoprene copolymers, and mixtures of these elastomers.

Even more preferentially, the second elastomer is a diene elastomer chosen from natural rubber (NR) and synthetic polyisoprenes (IR).

In summary, the butyl rubber of the composition in accordance with the invention is preferentially chosen from the group of essentially saturated diene elastomers consisting of copolymers of isobutylene and of isoprene and halogenated derivatives thereof, it being possible for this essentially saturated elastomer to be used as a blend with an elastomer chosen from the group of the highly unsaturated diene elastomers consisting of polybutadienes (abbreviated to “BRs”), synthetic polyisoprenes (IRs), natural rubber (NR), butadiene copolymers, isoprene copolymers, butadiene/styrene copolymers (SBRs), isoprene/butadiene copolymers (BIRs), isoprene/styrene copolymers (SIRs) and isoprene/butadiene/styrene copolymers (SBIRs) and the mixtures of these elastomers, and preferably with an elastomer chosen from natural rubber (NR) and synthetic polyisoprenes (IR).

According to one embodiment, the butyl elastomer (or the mixture of butyl elastomers) is (are) the predominant elastomer of the rubber composition of the invention; i.e. the butyl rubber(s) that may be used in the composition of the present invention represent at least 50 phr, i.e. they represent at least 50% by weight relative to the total weight of the elastomeric matrix. Preferably, the content of butyl rubber or of mixture of butyl rubbers is strictly greater than 50 phr, preferably strictly greater than 55 phr.

More preferably in this embodiment, the butyl rubber(s) have a content ranging from 70 to 95 phr, preferably ranging from 85 to 95 phr.

In another variant, the butyl elastomer (or the mixture of butyl elastomers) is (are) the only elastomer(s) of the elastomeric matrix, in other words the content of butyl elastomer or of mixture of butyl elastomers in the composition is equal to 100 phr.

Carbon Black

As seen previously, the composition of the invention comprises carbon black in a content ranging from 2 to 15 phr,

Carbon black is a reinforcing filler, well known to those skilled in the art, which is used in rubber compositions.

For the purposes of the present invention, the term “reinforcing filler(s)” means fillers of any type known for their capacity to reinforce a rubber composition which may be used for the manufacture of tyres, i.e. known especially for improving the properties of this composition. The reinforcing properties of a reinforcing filler may be measured via any technique known to those skilled in the art, especially by measuring the dynamic properties of a composition into which the reinforcing filler has been introduced and by plotting the modulus/elongation curves. The dynamic properties are measured according to the standard NF T-46-002 of September 1988.

All carbon blacks, especially blacks of the HAF, ISAF or SAF type, conventionally used in tyres (“tyre-grade” blacks) are suitable as carbon blacks. Among the latter, mention will be made more particularly of the reinforcing carbon blacks of the 100, 200 or 300 series (ASTM grades), for instance the N115, N134, N234, N326, N330, N339, N347 or N375 blacks, or else, depending on the applications targeted, blacks of higher series (for example N660, N683 or N772), or even N990.

Needless to say, it is possible to use just one carbon black or a blend of several carbon blacks of different ASTM grades.

Preferably, the carbon black content in the rubber composition ranges from 2 to 9 phr.

Graphite

As seen previously, the composition of the invention comprises graphite in a content of greater than or equal to 60 phr.

Graphite is a semi-reinforcing filler used in rubber compositions.

Semi-reinforcing fillers are not capable by themselves of reinforcing a rubber composition intended for the manufacture of tyres. In other words, they are not capable of replacing, in its reinforcing function, a conventional tyre-grade carbon black, but they allow an increase in the tensile modulus of a rubber composition into which they are incorporated, which is why they are referred to as being “semi-reinforcing”. The tensile moduli are measured according to the standard NFT 46-002 of September 1988.

The term “graphite” generally means an assembly of non-compact hexagonal sheets of carbon atoms: graphenes. Graphite, a hexagonal crystalline system, has a stack of ABAB type in which the B plane is translated relative to the A plane; it belongs to the crystal group: P63/mmc space group.

Given these definitions, the term “graphite which may be used according to the invention” more particularly means:
(a) any natural graphite, associated with rocks affected by metamorphism, after the separation of the impurities accompanying the graphite veins and after milling;
(b) any thermally expandable natural graphite, i.e. in which a chemical compound in the liquid state, for example an acid, is intercalated between its graphene planes;
(c) any expanded natural graphite, the latter being produced in two stages: intercalation of a chemical compound in the liquid state, for example an acid, between the graphene planes of a natural graphite by chemical treatment, and high-temperature expansion;
(d) any synthetic graphite obtained by graphitization of petroleum coke.

The rubber composition according to the invention may contain a single graphite or a mixture of several graphites; thus, there may be a blend of natural graphite and/or of expanded graphite and/or of synthetic graphite.

The graphite as defined previously may be morphologically in a lamellar or non-lamellar form.

Preferably, the graphite is in lamellar form.

Preferably, the graphite content in the rubber composition of the invention is less than or equal to 100 phr.

Preferably, the graphite content in the composition of the invention is greater than or equal to 65 phr, preferably greater than or equal to 70 phr, more preferentially greater than or equal to 75 phr.

In other words, the graphite content in the composition of the invention may range, for example, from 60 phr to 100 phr, preferably from 65 phr to 100 phr, more preferably from 70 phr to 100 phr and even more preferably from 75 phr to 100 phr.

The Applicants have found that specific contents of graphite as described above associated with a low content of carbon black as described previously in a rubber composition makes it possible to obtain rubber compositions which simultaneously have good impermeability, especially with respect to gases, and also mechanical properties such as the breaking stress and the breaking energy that are improved relative to the compositions of the prior art.

Plasticizing Oil

As mentioned previously, the rubber composition comprises at least one plasticizing oil, the content of which is less than or equal to 30 phr.

By definition, a plasticizing oil (also known as a liquid plasticizer) is liquid at room temperature (23° C.) and at atmospheric pressure (1.013×10⁵ Pa), which is compatible, i.e. miscible at the content used, with the rubber composition for which it is intended, so as to act as a true diluent.

The rubber composition of the invention may contain only one plasticizing oil or a mixture of several plasticizing oils. In the rest of the present description, the term “plasticizing oil” or the term “plasticizing oils” is used, unless expressly mentioned otherwise, to denote equivalently a plasticizing oil or a mixture of plasticizing oils.

This or these plasticizing oil(s) generally have a low glass transition temperature, of less than −20° C. (Tg, measured according to ASTM D3418), preferably of less than −40° C.

The glass transition temperatures are measured in a known manner by DSC (Differential Scanning Calorimetry) according to the standard ASTM D3418.

As plasticizing oil that may be used in the inner liner according to the invention, use may be made of any “extender” oils, whether they are of aromatic or non-aromatic nature, known for their plasticizing properties with respect to the elastomers used in the present invention.

Plasticizing oils chosen from the group consisting of liquid diene polymers, polyolefin oils, naphthenic oils, paraffinic oils, DAE (Distillate Aromatic Extracts) oils, MES (Medium Extracted Solvates) oils, TDAE (Treated Distillate Aromatic Extracts) oils, RAE (Residual Aromatic Extracts) oils, TRAE (Treated Residual Aromatic Extracts) oils, SRAE (Safety Residual Aromatic Extracts) oils, mineral oils, vegetable oils, ether plasticizers, ester plasticizers, phosphate plasticizers, sulfonate plasticizers, and mixtures of these compounds, are particularly suitable for use.

Liquid polymers resulting from the polymerization of olefins or dienes, such as, for example, those selected from the group constituted by polybutenes, polydienes, in particular polybutadienes, polyisoprenes, copolymers of butadiene and isoprene, copolymers of butadiene or isoprene and styrene, and the mixtures of these liquid polymers, are also suitable for use. The number-average molar mass of such liquid polymers is preferentially within a range extending from 500 g/mol to 50 000 g/mol, more preferentially from 1000 g/mol to 10 000 g/mol. By way of example, mention may be made especially of the Ricon products from the company Sartomer.

Functionalized or non-functionalized polyisobutylene oils with a molecular mass of between 200 g/mol and 40 000 g/mol are also suitable for use.

According to another preferential embodiment of the invention, the plasticizing oil(s) are vegetable oils (such as linseed oil, safflower oil, soybean oil, maize oil, cottonseed oil, rapeseed oil, castor oil, tung oil, pine oil, sunflower oil, palm oil, olive oil, coconut oil, peanut oil, grapeseed oil, and mixtures of these oils, in particular a sunflower oil).

According to another specific embodiment of the invention, the plasticizing oil(s) are an ether, for instance polyethylene glycols or polypropylene glycols.

Plasticizing oils chosen from the group consisting of ester plasticizers, phosphate plasticizers, sulfonate plasticizers, and mixtures of these compounds, are also suitable for use. Preferentially, the plasticizing oil is chosen from liquid diene polymers, naphthenic oils, paraffinic oils, MES oils, TDAE oils, mineral oils, plant oils, ether plasticizers, ester plasticizers, phosphate plasticizers, sulfonate plasticizers, and mixtures of these compounds.

Preferentially, the content of plasticizing oil in the composition is greater than or equal to 5 phr.

Advantageously, the content of plasticizing oil in the composition ranges from 5 phr to 30 phr, preferably from 10 phr to 20 phr.

Plasticizing Resin

As mentioned previously, the composition according to the invention comprises at least one plasticizing resin in a content of less than or equal to 5 phr.

In contrast with plasticizing oils, the term “plasticizing resin” means a compound which is solid at room temperature (23° C.) and at atmospheric pressure (1.013×10⁵ Pa).

This or these plasticizing resin(s) generally have a glass transition temperature of greater than 20° C. (Tg, measured according to ASTM D3418), preferably of greater than 30° C.

The rubber composition of the invention may contain only one plasticizing resin or a mixture of several plasticizing resins. In the rest of the present description, the term “plasticizing resin” or the term “plasticizing resins” is used, unless expressly mentioned otherwise, to denote equivalently a plasticizing resin or a mixture of plasticizing resins.

Preferably, the plasticizing resins that may be used in the compositions according to the invention are hydrocarbon-based plasticizing resins.

Hydrocarbon-based resins are polymers that are well known to those skilled in the art, which are thus miscible by nature in elastomer compositions, when they are additionally described as “plasticizing”.

These hydrocarbon-based plasticizing resins generally have a glass transition temperature of greater than 20° C. and a softening point of less than 170° C. The softening points are measured according to the standard ASTM E-28.

They have been widely described, for example in the book entitled “Hydrocarbon Resins” by R. Mildenberg, M. Zander and G. Collin (New York, VCH, 1997, ISBN 3-527-28617-9), Chapter 5 of which is devoted to their applications, in particular in the tyre rubber field (5.5. “Rubber Tires and Mechanical Goods”).

They may be aliphatic, naphthenic or aromatic or else of the aliphatic/naphthenic/aromatic type, that is to say based on aliphatic and/or naphthenic and/or aromatic monomers. They may be natural or synthetic and may or may not be based on petroleum (if such is the case, they are also known under the name of petroleum resins). They are preferentially exclusively hydrocarbon-based, i.e. they include only carbon and hydrogen atoms.

Preferentially, the resin content in the rubber composition according to the invention ranges from 0 to 5 phr.

Other Additives

The rubber composition according to the invention may also include all or a portion of the usual additives usually used in elastomer compositions intended for the manufacture of tyres, for instance protective agents such as chemical antiozonants, antioxidants, anti-fatigue agents, methylene acceptors (for example phenolic novolac resin) or methylene donors (for example HMT or H3M), a crosslinking system based either on sulfur, or on sulfur donors and/or on peroxide and/or on bismaleimides and/or vulcanizing resins, vulcanization accelerators or vulcanization activators.

### Manufacture of the Compositions of the Invention

The rubber composition according to the invention may be manufactured in appropriate mixers using two successive preparation phases well known to those skilled in the art.

By way of example, the non-productive phase is performed in a single thermomechanical step during which, in a first stage, all the base constituents (the butyl rubber(s), the optional other elastomer(s), the optional plasticizing oil and/or resin, the carbon black and the graphite) are introduced into an appropriate mixer, such as a standard internal mixer, followed, in a second stage, for example after kneading for one to two minutes, by the optional other additives with the exception of the crosslinking system. The total duration of the kneading, in this non-productive phase, is preferably between 1 and 15 min.

After cooling the mixture thus obtained, the crosslinking system is then incorporated in an external mixer, such as an open mill, maintained at a low temperature (for example between 40° C. and 100° C.). The combined mixture is then mixed (productive phase) for a few minutes, for example between 2 and 15 min.

The actual crosslinking system is preferentially based on sulfur and on a primary vulcanization accelerator, in particular on an accelerator of the sulfenamide type. Various known secondary vulcanization accelerators or vulcanization activators, such as zinc oxide, stearic acid, guanidine derivatives (in particular diphenylguanidine), and the like, are added to this vulcanization system, being incorporated during the first non-productive phase and/or during the productive phase. The sulfur content is preferably between 0.5 and 3.0 phr and the content of the primary accelerator is preferably between 0.5 and 5.0 phr.

Use may be made, as (primary or secondary) accelerator, of any compound capable of acting as accelerator of the vulcanization of the elastomers according to the invention in the presence of sulfur, in particular accelerators of the thiazole type and derivatives thereof and accelerators of the type such as thiurams and zinc dithiocarbamates. These accelerators are more preferentially chosen from the group consisting of 2-mercaptobenzothiazyl disulfide (abbreviated as MBTS), N-cyclohexyl-2-benzothiazylsulfenamide (abbreviated as CBS), N,N-dicyclohexyl-2-benzothiazylsulfenamide (abbreviated as DCBS), N-tert-butyl-2-benzothiazyl sulfenamide (abbreviated as TBBS), N-tert-butyl-2-benzothiazylsulfenimide (abbreviated as TBSI), zinc dibenzyldithiocarbamate (abbreviated as ZBEC), and mixtures of these compounds.

Preferably, use is made of a primary accelerator of the sulfenamide type.

The final composition thus obtained may then be calendered, for example in the form of a sheet or of a plaque, in particular for laboratory characterization, or else extruded, for example in order to form a rubber profiled element used for tyre manufacture or, for example, for the manufacture of an inner liner.

### Use of the Composition of the Invention

The rubber composition according to the invention may be used in any type of object requiring protection of elements against the ingress of oxygen and water. For example, the rubber composition according to the invention may be used as an inner liner in boats, such as inflatable dinghies, balls used for games or sports, tyres, etc.

Thus, one subject of the present invention is an inner liner comprising at least one composition as defined previously.

The invention also relates to a tyre comprising at least one rubber composition as defined previously.

Moreover, the invention also relates to a tyre comprising at least one inner liner as defined previously.

In general, the tyre according to the invention is intended to equip motor vehicles of private passenger type, SUVs (sport utility vehicles), two-wheeled vehicles (especially motorbikes), aeroplanes, and also industrial vehicles such as vans, heavy-goods vehicles and other transportation or material-handling vehicles.

### Preferred Embodiment of the Rubber Compositions of the Invention

Among the preferred embodiments of the invention, mention may be made of:
a rubber composition comprising at least one butyl elastomer or a mixture of butyl elastomer in a content of greater than 55 phr, preferably in a content ranging from 70 phr to 90 phr, carbon black in a content ranging from 2 to 9 phr, graphite, the content of which is greater than or equal to 65 phr, preferably ranging from 65 phr to 100 phr, and a plasticizing oil, the content of which ranges from 5 to 30 phr, preferably from 10 to 20 phr; the preferred characteristics of each of the constituents as described above apply to this embodiment,
a rubber composition comprising at least one butyl elastomer or a mixture of butyl elastomer in a content equal to 100 phr, carbon black in a content ranging from 2 to 9 phr, graphite, the content of which is greater than or equal to 65 phr, preferably ranging from 65 phr to 100 phr, and a plasticizing oil, the content of which ranges from 5 to 30 phr, preferably ranging from 10 to 20 phr; the preferred characteristics of each of these constituents as described above apply to this embodiment.

The invention and the advantages thereof will be more thoroughly understood in the light of the implementation examples that follow, which shall not be construed as limiting the invention.

### EXAMPLES

### A) Preparation and Tests of the Rubber Compositions

The following tests are performed in the following manner: the butyl rubber(s), the other elastomer(s) if they are present, the carbon black and the graphite, and the plasticizing resin and/or the plasticizing oil if they are present in the rubber composition, and also the various other ingredients with the exception of the vulcanization system, are successively introduced into an internal mixer (final degree of filling: approximately 70% by volume), the initial vessel temperature of which is approximately 60° C.

Thermomechanical working is then performed (non-productive phase) in one step, which lasts in total for approximately 3 to 4 min, until a maximum “dropping” temperature of 140° C. is reached.

The mixture thus obtained is recovered and cooled and then sulfur, an accelerator of sulfenamide type and the other elements of the vulcanization system are incorporated on a mixer (homofinisher) at 30° C., the whole being mixed (productive phase) for an appropriate time (for example between 5 and 12 min).

The compositions thus obtained are subsequently calendered, either in the form of plaques (thickness of 2 to 3 mm) or thin sheets of rubber, for measurement of their physical or mechanical properties, or extruded in the form of tyre inner liners.

### B/Test Compositions

The object of the examples presented in Table 1 is to compare the various rubber properties of a series of compositions C1 to C4 in accordance with the invention with a control composition T1 corresponding to the prior art EP2671917. The results of the properties measured after curing are presented in Table 2.

The contents of the various constituents of the compositions presented in Table 1 are expressed in phr (parts by weight per hundred parts by weight of elastomer).

TABLE 1

| | T1 | C1 | C2 | C3 | C4 |
|---|---|---|---|---|---|
| Butyl rubber (1) | 100 | 100 | 100 | 100 | 100 |
| Carbon black (2) | 5 | 5 | 5 | 5 | 5 |
| Graphite (3) | (—) | 80 | 65 | 80 | 80 |
| Clay (4) | 80 | (—) | (—) | (—) | (—) |
| Plasticizing oil (5) | 10 | 10 | 15 | 15 | 20 |
| Sulfur | 0.75 | 0.75 | 0.75 | 0.75 | 0.75 |
| MBTS (6) | 0.6 | 0.6 | 0.6 | 0.6 | 0.6 |
| ZnO | 0.75 | 0.75 | 0.75 | 0.75 | 0.75 |
| Stearic acid | 1.5 | 1.5 | 1.5 | 1.5 | 1.5 |

(1) Brominated polyisobutylene sold under the reference BB2222 by the company ExxonMobil Chemical.
(2) Carbon black N772 Regal@SRF sold by Cabot Ravenne.
(3) Natural graphite sold by the company Imerys under the name LSG6
(4) Natural clay or kaolin Polwhite ™ KL sold by Imerys, with a specific surface area of 13 m²/g
(5) Oil TDAE Vivatec 500 sold by Repsol
(6) 2-Mercaptobenzothiazyl disulfide sold by General Quimica SAU

Composition T1 is a control composition.

Composition C1 in accordance with the invention differs from composition T1 in that the clay has been replaced with graphite.

Composition C2 in accordance with the invention differs from composition C1 by the content of graphite.

Compositions C3 and C4 in accordance with the invention differ from composition C1 by the content of plasticizing oil.

TABLE 2

| | T1 | C1 | C2 | C3 | C4 |
|---|---|---|---|---|---|
| Mean breaking | 100 | 168 | 151 | 159 | 134 |
| stress on a basis of | | | | | |
| 100 | | | | | |
| Breaking energy | 100 | 113 | 150 | 131 | 112 |
| on a basis of 100 | | | | | |
| Dynamic glass | −22.3 | −19.3 | −21.8 | −22.0 | −22.6 |
| transition | | | | | |
| temperature Tg | | | | | |
| (° C.) | | | | | |
| Permeability to | 100 | 72 | 102 | 77 | 85 |
| oxygen on a basis | | | | | |
| of 100 | | | | | |

Replacing the clay with graphite in the compositions in accordance with the invention C1 to C4 makes it possible to obtain either a reduction in the permeability to oxygen relative to composition T1 and thus an improvement in the impermeability for compositions C1, C3 and C4, or, for composition C2, a permeability to oxygen equivalent to that of composition C1.

Surprisingly, the use of a high content of graphite with a low content of carbon black in composition C1 makes it possible to improve the breaking stress properties and to improve the breaking energy relative to the control composition 1.

These improvements in breaking stresses and in breaking energy are also observed for compositions C2 to C4 according to the invention in which the content of graphite and of plasticizing oil vary.

Composition C1 according to the invention has cold rigidity properties slightly inferior to those of the control composition T1. This level however remains acceptable for use in a tyre.

Increasing the content of plasticizing oil in compositions C2 to C4 of the invention makes it possible to obtain cold rigidity properties equivalent to those of the control composition T1 and, surprisingly, while at the same time maintaining the impermeability properties, or even improving them.

1.-16. (canceled)

17. A rubber composition based on at least:
an elastomer;
carbon black in a content ranging from 2 to 15 phr;
graphite in a content of greater than or equal to 60 phr; and
a plasticizing oil, a content of which is less than or equal to 30 phr.

18. The rubber composition according to claim 17, wherein the graphite content is less than or equal to 100 phr.

19. The rubber composition according to claim 17, wherein the graphite content is greater than or equal to 65 phr.

20. The rubber composition according to claim 17, wherein the carbon black content is less than or equal to 9 phr.

21. The rubber composition according to claim 17, wherein the carbon black content ranges from 2 to 9 phr.

22. The rubber composition according to claim 17, wherein the elastomer is a butyl elastomer or a mixture of butyl elastomers.

23. The rubber composition according to claim 22, wherein the butyl elastomer or each butyl elastomer is selected from the group consisting of isobutylene polymers, copolymers of isobutylene and of isoprene, halogenated isobutylene polymers and halogenated copolymers of isobutylene and of isoprene.

24. The rubber composition according to claim 22 further comprising at least a second elastomer different from the butyl elastomer or mixture of butyl elastomers.

25. The rubber composition according to claim 24, wherein the second elastomer is a diene elastomer selected from the group consisting of polybutadienes, synthetic polyisoprenes, natural rubber, butadiene copolymers, isoprene copolymers and mixtures thereof.

26. The rubber composition according to claim 22, wherein a total content of butyl elastomer is greater than or equal to 50 phr.

27. The rubber composition according to claim 17 further comprising a plasticizing resin, a content of which is less than or equal to 5 phr.

28. The rubber composition according to claim 17, wherein the content of plasticizing oil is greater than or equal to 5 phr.

29. The rubber composition according to claim 17, wherein the content of plasticizing oil ranges from 5 to 30 phr.

30. The rubber composition according to claim 17, wherein the plasticizing oil is selected from the group consisting of liquid diene polymers, naphthenic oils, paraffinic oils, MES oils, TDAE oils, mineral oils, plant oils, ether plasticizers, ester plasticizers, phosphate plasticizers, sulfonate plasticizers, and mixtures thereof.

31. An inner liner comprising at least one rubber composition according to claim 17.

32. A tire comprising at least one rubber composition according to claim 17.

33. A tire comprising the inner liner according to claim 31.
